(19) United States
(12) Patent Application Publication
(10) Pub. No.: US 2005/0087978 A1
(43) Pub. Date: Apr. 28, 2005

(54) Universal form assembly having detachable label, sheet and envelope pouch

(76) Inventor: D. Mark Tucker, Fort Scott, KS (US)

Correspondence Address: WARD KRAFT, INC., P.O. BOX 938, FORT SCOTT, KS, 66701, US

(21) Appl. No.: 10/691,263

(22) Filed: Oct. 22, 2003

(51) Int. Cl. B42D 15/00

(52) U.S. Cl. 283/105

(57) ABSTRACT

The present invention relates to a combination shipping label, containment envelope and packing list that can be produced in a relatively planar configuration suitable for use with non-impact printers. The business form construction provides for a relatively full sized sheet to contain shipping or contents information, containment envelope of suitable size to hold the packing list or other component parts that may be shipped in connection with a particular package as well as a separable return or shipper information label to designate the origin of the package.

### CROSS-REFERENCES TO RELATED APPLICATIONS

None.

### FIELD OF THE INVENTION

The present invention relates to a business form shipping label combination that provides a construction and design that is multi-functional and which is simple and efficient to use and produce. The present invention provides a relatively homogenous assembly in that it combines an information carrying portion, label and shipping envelope in a single, relatively planar structure. The business form of the present invention may be used for shipping documentation, instructions, parts and provides for additional integral elements, including a pick/pack list and containment envelope all in one single unitary construction. The contrivance is unique in character and highly versatile in that it may be used for shipping information and for packaging label components as well as other applications such as the creation of time capsule devices, secure records holder, document retention packet, material safety data sheets (“MSDS”), documents, technical data sheet carrier, emergency instructions holder, hardware packaging list, label and envelope for containing loose parts or components (i.e., screws, nuts, bolts, puzzle pieces, etc.).

### BACKGROUND OF THE INVENTION

Shipping labels have historically been used to ship parcels, packages, freight and the like between destinations. The shipping label as the name conjures up, usually includes a label but also may include other component parts in order to provide additional information to the shipper and receiver without having to open up the package and inspect the contents.

The prior art shipping configurations have heretofore been typically supplied in separate or individual components, which include, labels, shipping envelopes, and contents lists. While such elements are commonly known and can be provided at relatively commodity pricing levels having three totally separate articles or embodiments can be difficult to use in that the user must locate each piece of the shipping components prior to sending the package out to the intended recipient. In addition, this arrangement requires the user to have a ready supply of each of the items on hand each time he/she wishes to ship a package. Where one is short of one of the elements, for example the shipping envelope, then the user is forced to postpone the shipping activity until additional envelopes can be procured.

Attempts have been made to produce single structures in which there is provided a label, business form component and envelope or protective sleeve. One such example was produced as a continuous business form, having a series of plies connected along a single end edge or margin. Each of the plies could then be snapped apart, creating what is referred to as a “snap set.”

The upper most plies were typically used for recording information and utilized either carbon interleaves or carbonless coatings that would enable the image imparted to the upper most layers to transfer to the layers beneath the construction. The lower most or base ply was often provided with an adhesive coating and a release liner, so that upon removal of the release liner the form assembly could be adhered to a package or other container to be shipped. In later iterations of this construction, a clear plastic ply may have also been included on the back ply, opposite the adhesive coated portion with an opening on one end. This would enable the user to remove one of the upper most plies having recorded information thereon and insert one of the plies internally of the clear plastic ply thus serving as a ship to and from address label.

While the foregoing construction was suitable for point of application use, that is the shipper would impart a stylus or other writing implement to the surface of the business form assembly so as to create the necessary shipping information at the packing area, the prior art business form did not readily adapt itself to more automated processing needs associated with computer and non-impact printing devices such as laser and ink jet printers.

A derivation of the shipping label and in order to adapt to advancements in desktop technology was to create a larger label configuration that was printable by non-impact printers. This construction permitted the shipper to print the outgoing address on the face of a label sheet and then provide a contents listing on another part of the label sheet. This secondary portion was then folded under the face of the sheet, and then through a series of die cuts, a portion of the face of the sheet was removed and the entire construction adhered to a carton for shipment. While overcoming the foregoing drawbacks associated with advancements in technology, this approach did away with the envelope thereby limiting the amount of information that could be inserted underneath the outgoing label. That is, the amount of information was limited to the small tab that was capable of being tucked under the larger outgoing shipping label. In addition, as there was no envelope to view the shipping list, or even if an envelope was provided, the printed portion of the shipping list would be positioned against the face of the carton thus making it unreadable. Thus, a recipient of the package may not be able to confirm the contents of the package and as such, the recipient in an effort to gain access to the list may end up destroying the shipping label arrangement, when the label still may be needed for further transport or disposition.

Still other problems persist with the snap apart form set as well as the foregoing prior art “tuck under” constructions in that these constructions provide only a limited amount of space for printing or imaging information that is to be provided to the recipient on the information recording portion. The limitation was further exacerbated by the size of the provided envelope, either through the one created in the form set or alternatively, the area of the label under which the information portion is tucked. This then typically resulted from the shipper still having to place additional information within the package or container or reduce the size of the printed information or worse, eliminate steps such as in assembly instructions that the manufacturer may believe are obvious. Thus, upon receipt, if the information available on the exterior of the package was insufficient, the recipient was still forced to open the package and “fish” around for any additional information that the shipper may have included.

Other problems with prior art form constructions of the “tuck under” variety related to the use of thermal paper for use in thermal printers. Where the shipping label was exposed to the sun, such as on a dock, or near heat, the label could become distorted or discolored as the pigments of the label would have a tendency to “blacken” upon the application of the unintended heat. This would make the parcel largely undeliverable to the end user or recipient as the information would be destroyed by the blackening of the label.

Therefore, what is needed is a user friendly construction that overcomes the time constraints required with the procurement of three separate articles most commonly found and used in the world of trade and economic activity as well as an assembly that enables efficient use of today's desktop and high speed printer technology and provides the user with full sized documents and without limiting the user to any of the aforementioned drawbacks stated above.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

In our ever so changing world and pursuit of efficiency and productivity, the present invention improves time and motion along with all other associated costs and extracurricular recreation with the three aforementioned embodiments (label, envelope, and list) hereby constructed and designed all into one separate entity or embodiment.

In an exemplary embodiment of the present invention, a business form label combination is described and includes a substrate that has first and second faces, each of the first and second faces has an area for receiving indicia. The substrate is separable into first and second sections of unequal portions. A pattern of adhesive is applied to one of the first and second sections and a liner material is applied to one of the first and second sections in an area occupied by the pattern of adhesive.

Continuing with the presently described embodiment, a first line of weakness is applied to the substrate so as to separate the substrate into first and second sections. A second line of weakness is provided in the substrate and the second line of weakness runs substantially perpendicular to the first line of weakness and through one of the first and second sections.

Next, in the presently described embodiment, a first substantially quadrate die cut is provided in only one of the first and second sections and in the area occupied by the pattern of adhesive. A second substantially quadrate die cut is provided inwardly of the first substantially quadrate die cut and is disposed only in the liner material covering the pattern of adhesive.

In a still further exemplary embodiment of the present invention a carton and shipping label combination is described and includes, a carton having a surface. A substrate that has first and second sections, with one of the first and second sections forming a label and a containment envelope and the other of the first and second sections forming a sheet for receiving indicia. The label of this presently described embodiment includes first and second surfaces and at least a first coating of adhesive that is applied to one of the first and second surfaces. The containment envelope that is formed from the substrate cooperates with the label to serve as a release ply for the label. The containment envelope has a front surface and a rear surface with a portion of each of the front and rear surfaces being at least partially translucent so that the contents of the shipping list are visible there through.

Still referring to the presently described embodiment, the containment envelope is provided with a perimeter of adhesive such that the containment envelope can be applied to a carton. The sheet which is used for preparing shipment information is provided integrally with the substrate and in a distinct area from the section of the substrate that forms the containment envelope and the label. The sheet is intended to be folded and inserted within the containment envelope. The containment envelope with the sheet is then applied to the surface of the carton along with the label.

In a yet still further embodiment of the present invention a shipping label, is described and includes a substrate having first and second surfaces with the substrate divided into first and second sections by one or more lines of weakness. The first section of the substrate has a plurality of substantially quadrate sections that are formed through the use of a series of die cuts. The second section of the presently described embodiment has a pattern of adhesive applied to a substantial portion of the second section and a release liner covering is provided and covers pattern of adhesive. The second section also has first and second substantially quadrate die cuts, with one of the die cuts spaced inwardly of the other die cuts. One of the first and second die cuts extends or is cut only through the substrate to form a removable label portion and the other of the die cuts forms an adhesive coated perimeter so that the release liner can be affixed to a carton through the adhesive coated perimeter.

Continuing with the description of this presently described embodiment, the first portion of the substrate is folded and configured to fit within an area created by the label after the label has been removed from the second portion, so that the first portion of the substrate (carrying the information) is visible and remains free of adhesive when disposed behind the release liner on the carton.

In a still further embodiment of the present invention, component part shipping assembly is described and includes, a substrate having first and second faces, each of the first and second faces has an area for receiving indicia. The substrate is separable into first and second sections, with one of the first and second sections having a dimension of a full sized sheet. By providing a full sized sheet of paper with which to record information, the shipper can provide sufficiently greater amounts of information to the intended recipient, which results in a significant improvement over the prior art constructions.

Continuing with a description of the presently described embodiment, a pattern of adhesive is applied to one of the first and second sections. A liner material is applied to the area occupied by the pattern of adhesive so that it covers the adhesive. The liner material has at least first and second substantially quadrate die cuts which with the pattern of adhesive forms a containment envelope or pouch. A first line of weakness applied to the substrate to separate the first and second sections from one another.

The presently described embodiment also includes a first substantially quadrate die cut provided in only one of the first and second sections and in the area occupied by the pattern of adhesive. A second substantially quadrate die cut provided inwardly of the first substantially quadrate die cut and is disposed only in the liner material covering the pattern of adhesive. At least one component having an edge is provided. The component may be a mechanical fastener or other part or element that has an edge which may be shipped to the user as part of the package or assembly.

The containment envelope of the presently described embodiment has a perimeter of adhesive so that the containment envelope can be applied to a carton. The full size sheet is provided for preparing shipment information and is intended to be folded and inserted within the containment envelope along with at least one component. The containment envelope with the sheet is applied to the surface of the carton along with the label.

The foregoing embodiments will be further clarified by referring to the following description and drawings.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1, depicts a front view of a business form label combination of the present invention;

FIG. 2, illustrates the obverse side or second face of a business form label combination of the present invention and illustrating the reverse printing provided in the containment envelope;

FIG. 3, shows a front view of a business form label combination in an alternative embodiment, such as for use in providing loose or component parts or pieces;

FIG. 4, provides a side view of a business form label combination of the present invention;

FIG. 5, depicts the shipping label of the present invention in conjunction with a package or container; and

FIG. 5A, illustrates a side view of container and shipping label combination of FIG. 5.

### DETAILED DESCRIPTION OF THE INVENTION

The present invention is now illustrated in greater detail by way of the following detailed description, but it should be understood that the present invention is not to be construed as being limited thereto.

The present invention is a single unitary business form, shipping label and containment envelope construction that is provided in a relatively or substantially planar configuration that is suitable for use in non-impact printers. The present invention, in one embodiment is composed of generally two sections (each of the sections can of course be divided into several other sections or portions), one of which creates the business form section.

The business form section can contain printed indicia such as a packing list, assembly instructions for products contained within the carton or container or other information relevant to the shipper or receiver. The business form section may be provided with one or more lines of weakness to enable the easy folding of the form section or to permit portions of the form section to be separated from the remainder of the form section such as to create a receipt portion or return label. The lines of weakness generally run perpendicular to one another and if equal segments of the business form section were to be provided; at least one of the lines of weakness would be disposed medially of the form section so as to create four equal sections. Obviously, other lines could be added or the lines could run diagonally so that unequal sections in the first or second section could be created depending on the needs of the end user.

The form section is separated from the other general section that makes up the label and containment envelope portion. The second section with a pattern of adhesive that coats generally, substantially all of the second section. The second section and the first section are separated from one another through a line of weakness that is spaced slightly outwardly of the pattern of adhesive, thereby creating a fairly clean line of demarcation between the two sections of the form.

The label and containment envelope section or second section has a release material that is applied over the adhesive pattern. Preferably, the release materials should be selected from a group of material that has some level of translucency or transparency so that the contents of the envelope may be witnessed from the exterior. In addition, such a transparent or translucence permits indicia, which may be reverse or mirror printed on containment envelope to be read or visible when looking at the container or package.

Where nut, bolts, screws, nails, other mechanical fasteners, or objects having edges that might break the surface of the containment envelope, the release material may be constructed of a heavier gauge material such as a plastic film such as polyethylene terephthalate (“PET”) which would still provide the necessary visibility as well as increased durability to prevent premature rupturing of the film ply due to the contact, rubbing or bumping of the edges of the contents against the surface of the envelope pouch.

Obviously, where confidentiality or sensitivity to light was important, one could also use a release liner material in which there was little or not transparency or translucency, so that the contents could be concealed from view or the contents protected from exposure to light. In addition, the release liner could be provided with some level of UV filtering to limit the amount of light entering the envelope where a transparent or translucent ply was being used.

The label is formed from a series of cooperating substantially quadrate die cuts, one of which permeates only the substrate from which the first and second portions of the assembly are formed and the second cuts only the release liner material which will form the outer face of the envelope construction.

As used herein, the term containment envelope or envelope construction includes at least one panel, which when secured against another panel, such as the panel of a carton or box, creates an envelope, pocket, pouch or the like suitable for holding the business form of the present invention or alternative components, parts, pieces (nuts, bolts, washers, rings, springs, puzzle pieces, wire nuts, wire ties, etc.) or combinations of the forgoing.

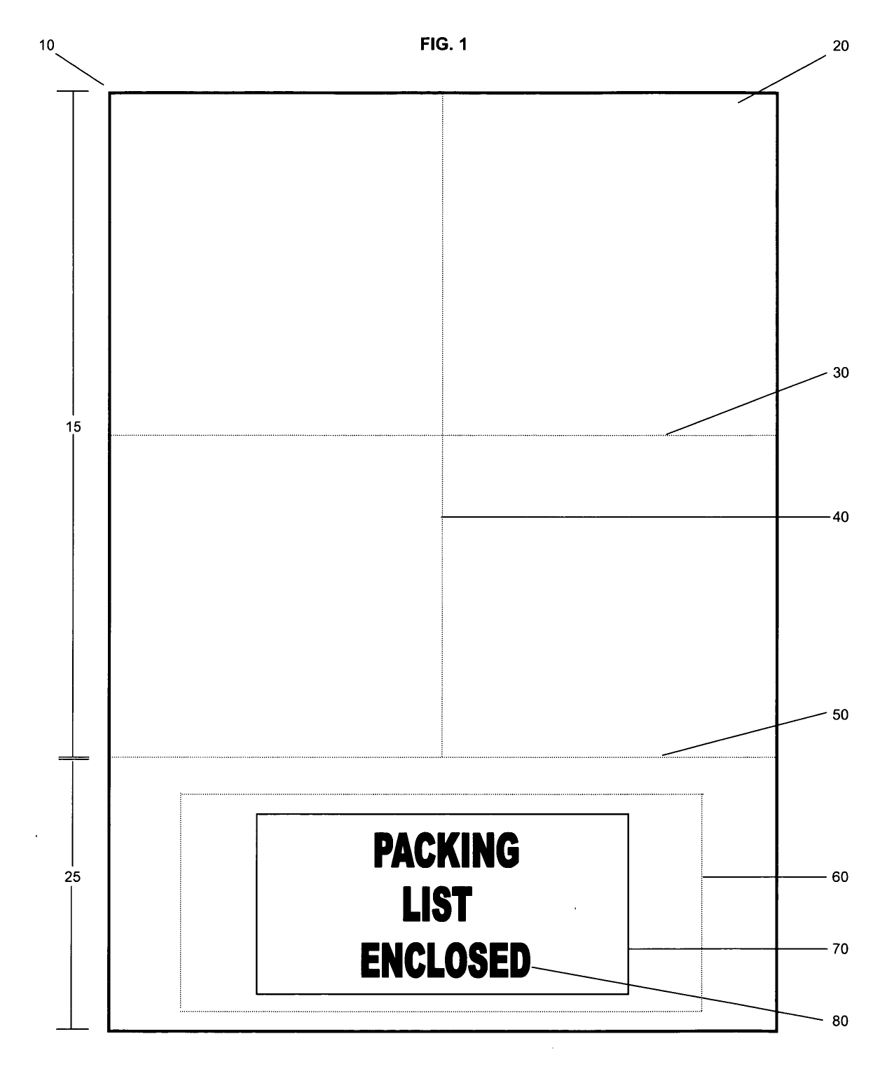

Turning now to FIG. 1, numeral 10 depicts generally one concept of the present invention. The business form shipping label is formed from a first substrate 20 that is divided into first and second portions or sections 15 and 25. The substrate face of the business form shipping label combination. The substrate has first and second faces or surfaces which are generally receptive to receiving printing, imaging as well as being coated with adhesive. The substrate 20 may be selected from any suitable material, but in an exemplary embodiment the substrate 20 is composed of twenty pound bond stock paper. Card or tag stock may however be used in certain instances and the bond weight may range as high as 100 pound stock.

The first portion 15 is provided with a series of lines of weakness 30, 40, and 50, which may be perforations, score lines or the like. Line of weakness 30 is disposed substantially medially (in the transverse direction) of the business form or first portion or section 15. Line of weakness 40 is disposed perpendicularly to line of weakness 30 and again runs substantially medially of the form in the longitudinal direction. By providing lines 30 and 40 in medial portions of the business form section 15, the form section 15 can be easily folded in to four equal components or parts so that it will easily fit within the envelope, the formation of which will be discussed later.

Alternatively, the lines of weakness can be used to create different sized or shaped areas or detachable receipt portions and the like. The lines may also run diagonally of the form section 15 so that other folded configurations are possible.

The first portion or section 15 is generally intended to receive printing, indicia, imaging and the like, such as one may find in connection with packing lists, assembly instructions, return instructions, use or operating instructions, greetings or other information that the shipper desires to pass along to the user. The shipper may also include detachable coupons through the use of one or more lines of weakness so that the recipient will be enticed to use the coupon in connection with a furniture order.

The first portion or section 15 may also be imaged with a photograph of how the product is supposed to be assembled. For example, if puzzle pieces are provided in the envelope pouch, the image can be used to assemble the puzzle which may then provide further clues on the contents of the package. Alternatively, the image may be of a finally assembled bicycle so that parents know what is inside and do not have to open the package prior to the holiday or gift giving opportunity and can merely present the package to the recipient and show the colored image.

Line of weakness 50 is provided to separate the first portion or section 15 from the second portion or section 25. The line of weakness 50 is typically a line of perforations having between ten to fifteen ties and cuts per inch and enables the business form section 15 to be removed from the remainder of the substrate 20, or section 25.

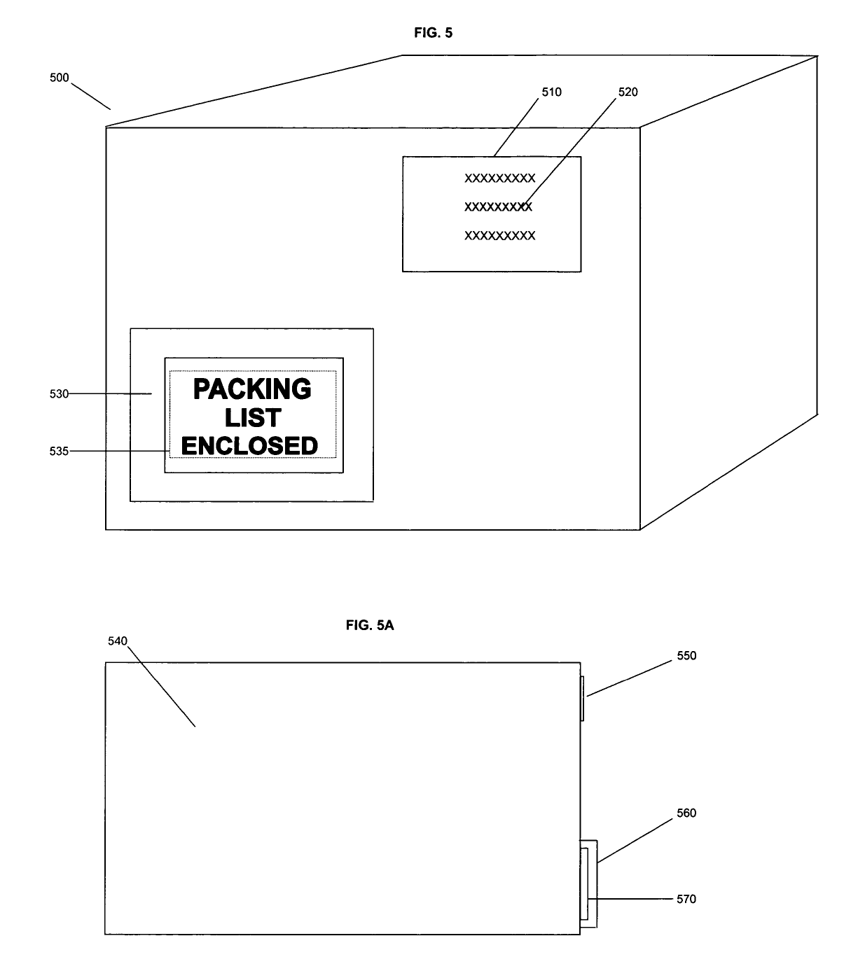

The second section 25 makes up the portions of the shipping label assembly that will form the containment envelope and shipping label (see FIG. 5, 530 and 510, respectively). The second area is provided with a pair of substantially quadrate (ranging from square to rectangular) die cuts 60 and 70. Die cut 70 is provided so that it cuts through the substrate 20 of the present invention 10 but not through the liner or release material (not shown). The die cut 70 is used to generally depict the outline of a label (with liner or release material on obverse side—not shown) formed by die cutting through at least one of the two surfaces coated with an adhesive (not shown). The label, in this exemplary embodiment is used for attaching to a carton, box, package, and the like. The label, outlined by die cut 70 can be printed at the same time as that of the business form section 15 or may be printed at a subsequent time. For example, if a number of packages are to be shipped and each of the packages contain the same contents (e.g. holiday fruitcakes), the business form section would be printed with the ingredients, nutritional details, return information, care and storage data and the like. Then when an order is finally placed, the shipping label would be imaged with the recipients address information so that delivery may occur. As the shipping label business form combination of the present invention is provided in a substantially coplanar arrangement, passing the form assembly through a non-impact printer more than a single time would not pose any difficulty. Numeral 80 is provided to depict any arrangement of print, imaging or the like, depending on usage, in this case, the printing “PACKING LIST ENCLOSED” is used for placing on a carton to be shipped and showing to the recipient, through the transparent or translucent window the contents of the envelope (reference to FIG. 5).

The second substantially quadrate die cut 60 is shown in phantom in that it only cuts through the release material or liner. The second die cut 60 is spaced inwardly from the edge of the form and outwardly from the first substantially quadrate die cut 70. That is, the first substantially die cut 70 is spaced inwardly of the other substantially quadrate die cut 60. Die cut 60 is used to create the adhesive frame that will secure the envelope portion to the carton whereas die cut 70 is used to enable the label portion to be removed from the assembly 10.

The release liner may be selected from any suitable material such as glassine, machine glazed or machine finished paper, bond paper coated with a release agent such as silicone or the like. Where the envelope pouch created from the use of the release liner would be used to carry component parts, a heavier film material may be selected such as a polyethylene terephthalate (“PET”) or other films that provide sufficient release properties as well as strength and transparency when needed.

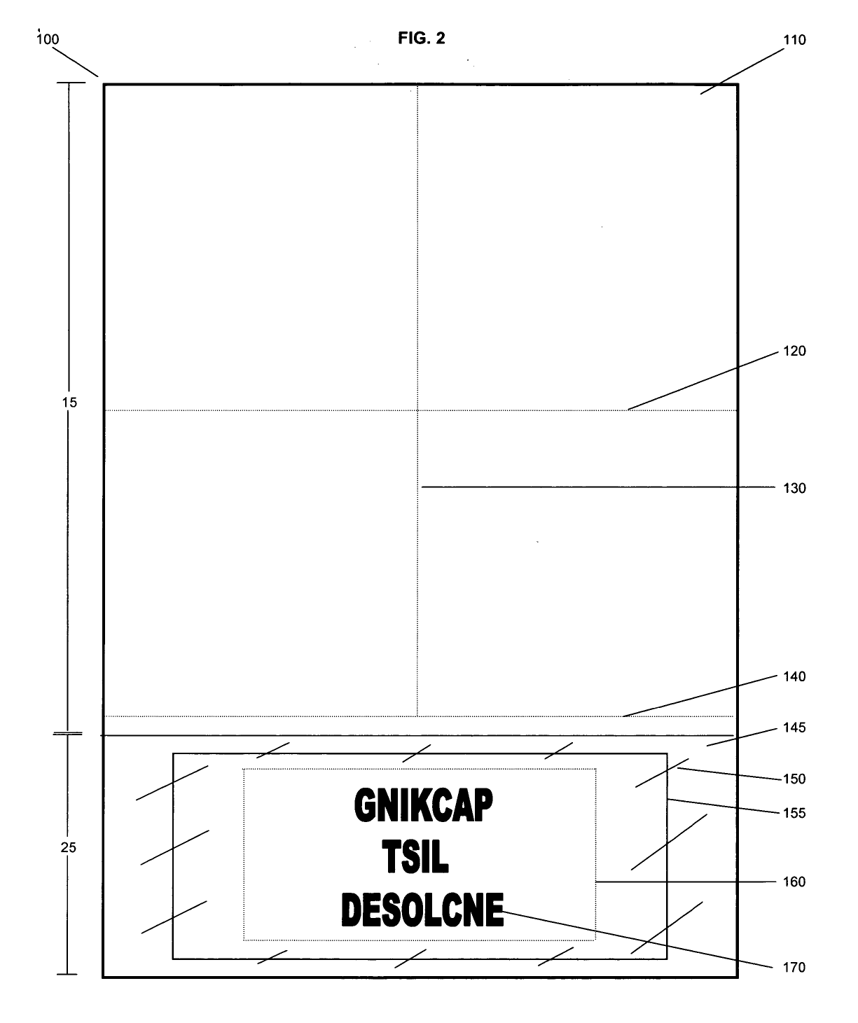

Referring now to FIG. 2, numeral 100 again depicts the combination shipping label and business form assembly of the present invention. Reference numeral 10 is used to refer to the back face or second face or surface of the substrate of the assembly 100. Lines of weakness 120, 130, and 140 are typically perforations, but can also be laser scoring or other cuts and are intended to cut completely through the first portion 15 (referring to FIG. 1). Where perforations are used the perforations have about 6 to about 50 cuts/ties per inch with about 10 to about 15 cuts/ties per inch being a standard plate. As described previously, the lines of weakness can be positioned in any sort of combination or arrangement so that the form can be folded or sections may be removed and detached from the assembly. Reference numeral 145 is used to show a transparent or translucent liner material to which a pattern of adhesive 150 has been applied. As can be seen from FIG. 2, the adhesive pattern covers substantially all of the area below line of weakness 140 which separates the first portion from the second portion of the form assembly. The adhesive of the present invention may be any suitable pressure sensitive adhesive and should generally be a permanent pressure sensitive adhesive so that upon application to a surface the label and the containment envelope cannot be readily removed without clearly indicating tampering has occurred.

The perimeter of the label 160 is depicted by a substantially quadrate die cut which is shown in phantom and is formed by die cutting, not through the liner side, but through the substrate on the first side. Die cut 155 is shown and is cut through the liner material 145 so as to create the frame for the envelope when a portion of the release liner is removed. Printing or indicia is provided at 170, and the printing is provided in a reverse printed format or mirror like image. That is, once the label is peeled away the printing is seen in its regular image or normal configuration.

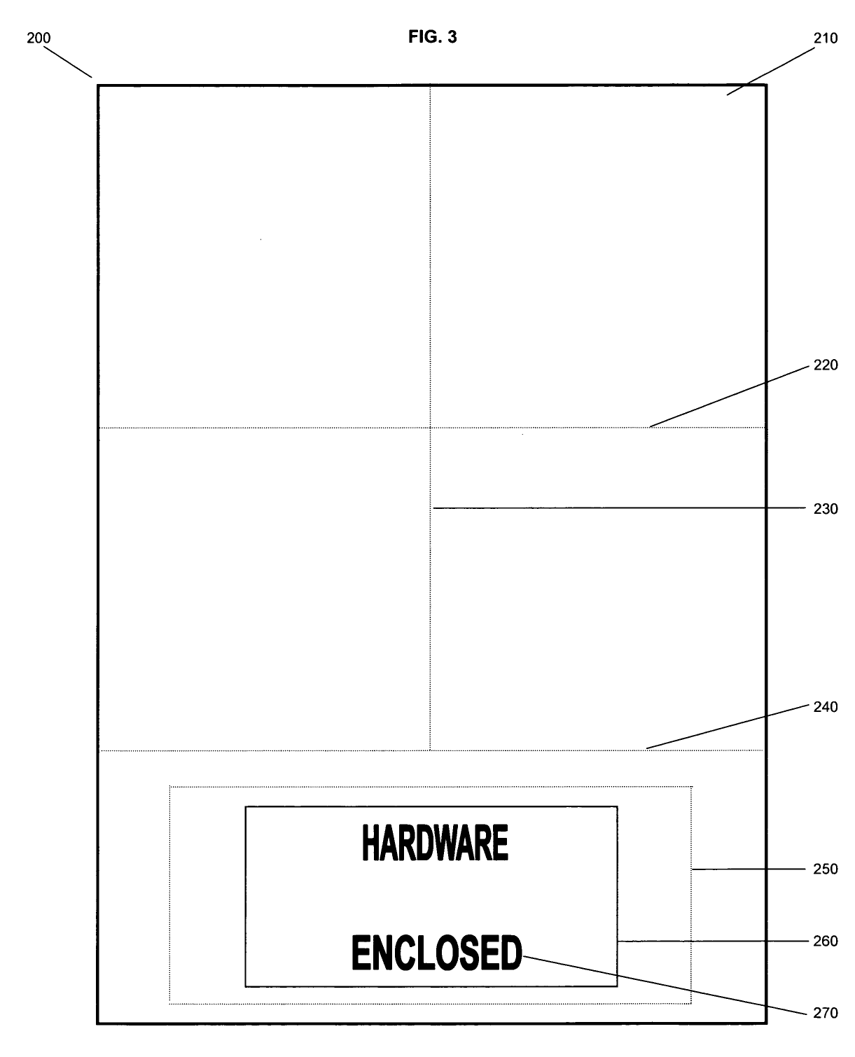

FIG. 3, depicts 200 as a concept. Numeral 210, depicts a surface. Numeral 220, 230, and 240 lines of weakness, in this case, perforations with the understanding of optional arrangements. Numeral 250 depicts an area to be cut for use of a containment envelope. Numeral 260 depicts a label (with liner on obverse side—not shown) formed by die cutting through at least one of two surfaces coated with an adhesive wherein the label, in this example, is used for attaching to a carton, box, package, and the like. Numeral 270 depicts any arrangement of print, depending on final use of contrivance, in this case, a hardware package used for containing screws, nuts, bolts, etc., used to assemble an apparatus and the like.

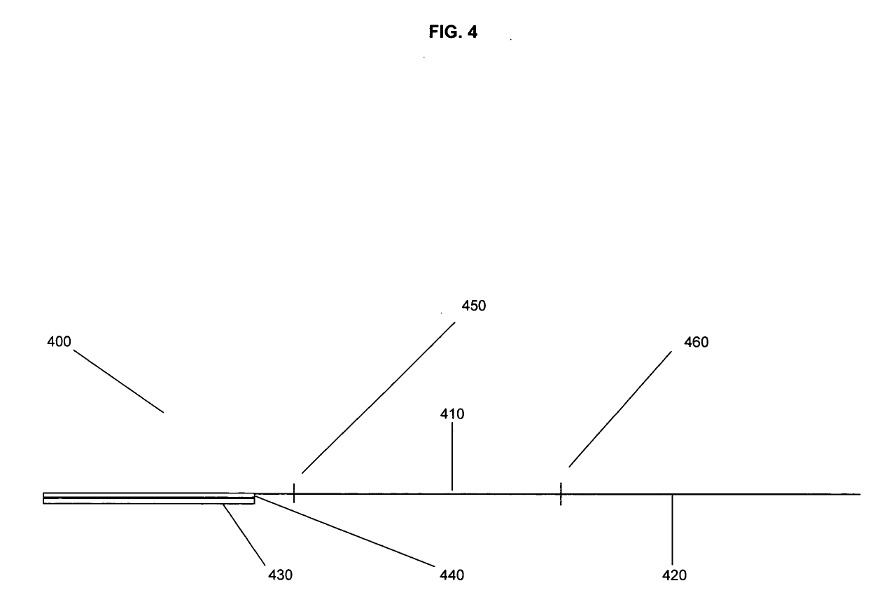

FIG. 4, depicts the side view of the present invention which is generally designated by reference to numeral 400. The substrate has a first face or surface 410 and a second face or surface 420. Numeral 430 is used to depict the liner or release material and numeral 440 depicts the pattern of adhesive. Numerals 450 and 460 are used to show the lines of weakness, in this example, perforations. Line of weakness 450 divides the form assembly into first and second sections. As can be clearly seen in the present FIG. 4 as well as the earlier FIGS. 1-3, the first and second sections have different dimensions, in at least the length dimension so that the sections are generally unequal. By providing a larger form section, the user of the business form shipping label assembly of the present invention can print or image significantly more information than that which was heretofore possible. For example, the assembly of the present invention can include a substrate having dimensions of 8½ inches wide by 17 inches long, in which an 8½ inch by 11 inch sheet makes up the business form section of the present invention and a roughly six inch portion of the substrate contributes to the formation of the second portion of the assembly (the label and containment envelope).

Reference is now directed to FIG. 5 of the present invention, in which reference numeral 500 illustrates a container or box used in one exemplary application of the present invention. In the presently described embodiment, the business form shipping label combination is used for shipping articles such as when used for shipping cartons, packages, parcels, freight and the like. Numeral 510 is depicted as the label portion that is detached and applied to a shipping carton 500. Numeral 520 is depicted to show indicia, wherein a company name, address, zip code, etc., can be printed on the label, 510. Numeral 530 is depicted as the containment envelope that is used and attached to the shipping carton through a portion of the pattern of adhesive that remains after the label 510 is removed and the additional matrix stripped away. Numeral 535 is depicted as a pick/pack list that can be printed on by the end-user and is produced using the business form section of the present invention. Through the use of the lines of weakness the pick/pack list folded and is placed conveniently inside the envelope or pouch that is created through the use of the release liner and the side wall of the carton 500.

Finally, turning now to FIG. 5A, numeral 540 depicts a side view of a carton. Numeral 550 depicts the attached label. Numeral 560 depicts the attached containment envelope. Numeral 570 depicts, in this example, a pick/pack list stuffed into the containment envelope, 560.

The present invention may be prepared using any conventional manufacturing techniques and in one exemplary embodiment, a sheet of stock material such as a twenty pound bond, having dimensions of roughly 8½″×17″. The sheet or substrate is fed to a coating station where the pattern of adhesive is applied to what will become the second portion of the business form assembly. A release liner or release material is brought into contact with the pattern of adhesive. Alternatively, a transfer tape can be used to affix the adhesive pattern and liner material to the substrate. Next, lines of weakness or perforations are cut into the substrate, first part to form the fold lines for the business form. A first die cut is added to the first face of the second portion to create the removable label. The first die cut does not penetrate the liner material lying beneath the second portion, only the substrate. A second die cut from underneath the form is then made and penetrates only the liner or release material. The dies to make the die cuts are generally cooperating rollers and the die cuts can be made at the same time when the form traverses the die station.

It should be understood that the steps of the forgoing process for producing the form may be conducted in any order depending on the efficiencies of the manufacturing line or the needs of the operator and as such manufacturing of the present invention is not as limited as by the presently described manufacturing process.

In use, a shipper would process the form and print either the business form section or the label section or both depending on current readiness of the package or parcel to be shipped. Next, the shipper would detach the business form section 15 along line of weakness 50 (referring to FIG. 1). The shipper would then peel the shipping label (demarcated by die cut 70) from the second portion 25 of the substrate 20 and apply the label to the carton shown in FIG. 5. Removal of the shipping label removes a portion of the adhesive from the release liner which will in effect create the window for the envelope to be secured to the carton. That is, after removal of the label and its adhesive coating, the transparent or translucent properties of the release liner can be used to view the contents inserted within the envelope or pouch once it is affixed to the surface of the carton.

Next, the shipper would remove a portion of the release liner that extends outwardly form die cut 60 so as to expose an adhesive that extends around the perimeter of the portion that will form the containment envelope. The containment envelope is now secured to the carton, again as shown in FIG. 5. The business form section 15 is then folded using lines of weakness 30 and 40 to form substantially quadrate sections that are suitable for insertion in the envelope assembly. It should be understood that the packing list or business form portion should first be applied adjacent the portion of the release liner that held the label material, as there is no longer any adhesive to interfere with or cling to the business form portion after the envelope is applied against the surface of the carton. This enables the business form portion to be readily removed from the envelope pouch, such as by slitting the material and then simply extracting the form as it has not been contaminated by any adhesive. By having a completely separable form portion, the recipient then does not have to take significant care in opening the assembly or to be weary of the folded under portions such as with tuck labels in the prior art.

To facilitate opening and use of the invention, the form assembly and universal construction may also be provided with use instructions or images that are printed on portions of the form that do not interfere with other areas of the form.

It will thus be seen according to the present invention a highly advantageous business form and shipping label combination has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

The inventor(s) hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A business form label combination comprising;
a substrate having first and second faces, each of said first and second faces having an area for receiving indicia, said substrate separable into first and second sections;
a pattern of adhesive applied to one of said first and second sections;
a liner material applied to one of said first and second sections in an area occupied by said pattern of adhesive;
a first line of weakness applied to said substrate to separate said first and second sections;
a first substantially quadrate die cut provided in only one of said first and second sections and in said area occupied by said pattern of adhesive; and
a second substantially quadrate die cut provided inwardly of said first substantially quadrate die cut and disposed only in said liner material covering said pattern of adhesive.

2. A business form label combination as recited in claim 1, wherein said first line of weakness is spaced outwardly from said pattern of adhesive.

3. A business form label combination as recited in claim 1, is used as a shipping label and is used in connection with a box, package, container and combinations thereof.

4. A business form label combination comprising as recited in claim 1, wherein said combination can be used as a time capsule device, secure records holder, document retention packet, MSDS envelope, technical data sheet carrier, emergency instructions holder, parts package and combinations thereof.

5. A business form label combination comprising as recited in claim 1, wherein a second line of weakness is provided and said second line of weakness runs substantially perpendicular to said first line of weakness and through one of said first and second sections.

6. A business form label combination comprising as recited in claim 1, wherein one of said first and second sections is a full sized sheet of paper for receiving information and said first and second sections are unequal portions.

7. A business form label combination comprising as recited in claim 6, wherein said full sized sheet of paper has dimensions of about 8½ inches by 11 inches.

8. A carton and shipping label combination comprising;
a carton having a surface;
a substrate having first and second sections, one of said first and second sections forming a label and a containment envelope and another of said first and second sections forming a full size sheet for receiving indicia;
said label having first and second surfaces, at least a first coating of adhesive applied to one of said first and second surfaces;
said containment envelope formed from said substrate and cooperating to serve as a release ply for said label, said containment envelope having a front surface and a rear surface, a portion of each of said front and rear surfaces is at least partially translucent;
said containment envelope having a perimeter of adhesive such that said containment envelope can be applied to a carton;
said full size sheet for preparing shipment information is provided integrally with said substrate and distinct from said section forming said containment envelope and said label, said full size sheet intended to be folded and inserted within said containment envelope; and
said containment envelope with said sheet is applied to said surface of said carton along with said label.

9. A carton shipping label combination as recited in claim 8, wherein said label and said containment envelope are formed from a plurality of substantially quadrate die cuts with one of the die cuts spaced inwardly of another of the die cuts.

10. A carton shipping label combination as recited in claim 8, wherein said sheet is provided in said first section and is separated from said label and said containment envelope which is provided in said second section by a first line of weakness.

11. A carton shipping label combination as recited in claim 10, wherein said sheet contains a second line of weakness running substantially perpendicular to said first line of weakness.

12. A carton shipping label combination as recited in claim 8, wherein said first line of weakness is spaced from said coating of adhesive.

13. A carton shipping label combination as recited in claim 8, wherein said containment envelope is provided with reverse printed indicia on said rear surface.

14. A carton shipping label combination as recited in claim 8, wherein said sheet is provided with a third line of weakness disposed perpendicularly to said second line of weakness and spaced from said first line of weakness.

15. A carton shipping label combination as recited in claim 14, wherein said third line of weakness is disposed substantially medially of said sheet.

16. A carton shipping label combination as recited in claim 8, wherein said full sized sheet has dimensions of about 8½ inches by 11 inches.

17. A shipping assembly, comprising;
a substrate having first and second surfaces and divided into first and second sections by one or more lines of weakness;
said first section having a plurality of substantially quadrate sections formed from a series of die cuts;
said second section having a pattern of adhesive applied to a substantial portion of said second section and a release liner covering said pattern of adhesive;
said second section further having first and second substantially quadrate die cuts, with one of said die cuts spaced inwardly of another of said die cuts, one of said first and second die cuts extending only through said substrate to form a removable label portion and another of said die cuts forming an adhesive coated perimeter so that said release liner can be affixed to a carton through said adhesive coated perimeter; and
said first portion is folded and configured to fit within an area created by said label after said label has been removed from said second portion, so that said first portion is visible and remains free of adhesive when disposed behind said release liner on said carton.

18. A shipping assembly as recited in claim 17, wherein said first portion is a full sized sheet of paper.

19. A shipping assembly as recited in claim 17, wherein said full sized sheet has dimensions of about 8½ inches by 11 inches.

20. A component part shipping assembly; comprising
a substrate having first and second faces, each of said first and second faces having an area for receiving indicia, said substrate separable into first and second sections, and one of said first and second sections having dimensions of a full sized sheet;
a pattern of adhesive applied to one of said first and second sections;
a liner material applied to one of said first and second sections in an area occupied by said pattern of adhesive, said liner material with at least first and second substantially quadrate die cuts and said pattern of adhesive forming a containment envelope;
a first line of weakness applied to said substrate to separate said first and second sections;
a first substantially quadrate die cut provided in only one of said first and second sections and in said area occupied by said pattern of adhesive, and a second substantially quadrate die cut provided inwardly of said first substantially quadrate die cut and disposed only in said liner material covering said pattern of adhesive;
at least one component having an edge;
said containment envelope having a perimeter of adhesive such that said containment envelope can be applied to a carton;
said full size sheet is provided for preparing shipment information and is intended to be folded and inserted within said containment envelope along with said at least one component; and
said containment envelope with said sheet is applied to said surface of said carton along with said label.
